(19) United States
(12) Patent Application Publication
(10) Pub. No.: US 2026/0008515 A1
(43) Pub. Date: Jan. 8, 2026

(54) ADAPTIVE CADENCE CONTROL OF A MOTOR-ASSISTED BICYCLE

(71) Applicant: enviolo B.V., Amsterdam (NL)

(72) Inventors: Marko MATENDA, Bjelovar (HR); Thomas William RYAN, IV, Leander, TX (US)

(21) Appl. No.: 19/258,760

(22) Filed: Jul. 2, 2025

Related U.S. Application Data
(60) Provisional application No. 63/666,958, filed on Jul. 2, 2024.

(51) Int. Cl. B62M 6/50

(52) U.S. Cl. CPC B62M 6/50

(57) ABSTRACT

A motor-assisted bicycle includes a transmission, an electric motor coupled to the transmission, one or more sensors, and an adaptive cadence control system communicatively coupled to the one or more sensors, the transmission and the electric motor. The adaptive cadence control system obtains initialization parameters, programming initial settings of the motor-assisted bicycle based on the initialization parameters, obtains operational signals of the motor-assisted bicycle, obtains cycling parameters, generates individual cadence adjustments, generates an overall cadence adjustment based on the individual cadence adjustments, generates one or more controlled variable settings based on the overall cadence adjustment, and controlling one or more operational control components of the motor-assisted bicycle based on the one or more controlled variable settings.

### CROSS REFERENCE TO RELATED APPLICATION

This application is a nonprovisional application of and claims the benefit of U.S. Provisional Application Ser. No. 63/666,958, entitled “ADAPTIVE CADENCE CONTROL,” filed Jul. 2, 2024, which is incorporated by reference in its entirety herein for all purposes.

### TECHNICAL FIELD

This disclosure pertains to motor-assisted vehicles, and more particularly to automatic control of a motor-assisted bicycle.

### BACKGROUND

A motor-assisted vehicle is a motorized vehicle with an integrated motor or engine that assists with vehicle propulsion. An electric bicycle (“e-bike”) is a type of motor-assisted bicycle in which the propulsion assist is provided by an integrated electric motor. E-bikes can generally be grouped into two categories: 1) those that assist the rider's pedal power, and 2) those that add a throttle and as such integrate moped-style functionality. Both categories of e-bikes retain the ability to be manually pedaled by a rider. One challenge is that the ability to adjust certain cycling parameters, such as a cadence, may be limited.

### SUMMARY

A motor-assisted vehicle is a vehicle in which propulsion assist is provided by an integrated motor or engine. An e-bike is an example motor-assisted bicycle with an integrated electric motor that provides the propulsion assist. The motor-assisted vehicle includes operational control components such as a drivetrain and the electric motor. A computing system may control the operational control components of the motor-assisted vehicle or cause the operational control components to be controlled. For example, the computing system generates and outputs one or more operational control signals that cause actuation of the operational control components.

The computing system may receive one or more cycling inputs. Cycling inputs may include one or more cycling setpoint parameters, one cycling adjustment parameters, or one or more motor assist parameters. The cycling setpoint parameters may include or indicate an initial cadence setpoint which establishes an initial or baseline cadence (e.g., pedal cadence). The cycling adjustment parameters may include or indicate an extent of cadence adjustment permitted relative to the cycling setpoint parameters during an upcoming time window (e.g., corresponding to an upcoming trip). The motor assist parameters may include an assist mode which includes protocols of providing assist torque to the e-bike. In some embodiments, the computing system initializes the e-bike based on the cycling inputs. In some embodiments, the computing system adaptively regulates upcoming cycling parameters based on the cycling inputs and based on one or more operational parameters derived or obtained from sensor signals. In general, upcoming cycling parameters may include variable locomotive characteristics of the motor-assisted vehicle, such as upcoming cadence or upcoming applied torque to pedals of the motor-assisted vehicle. In some embodiments, regulating upcoming cycling parameters includes regulating an upcoming cadence. In some embodiments, the operational parameters include a current or previous cadence, applied torque, velocity, or pitch. In some embodiments, at least some of the current or previous operational parameters correspond to a current or previous cycling parameter.

In some embodiments, adaptively regulating upcoming cycling parameters is according to an adaptive cadence control algorithm. The adaptive cadence control algorithm may be based on one or more cycling objectives such as increased rider comfort. For example, certain cycling conditions such as uphill roads, rough gravel, or dirt roads with loose surfaces may require increase in applied torque to the motor-assisted vehicle to traverse, assuming that the cadence remains constant. However, beyond a threshold applied torque, further increases in applied torque may be especially strenuous or infeasible. In this situation, the adaptive cadence control algorithm may increase cadence to prevent excessive increases in applied torque.

Adaptively regulating upcoming cycling parameters confers technical benefits such as smoothly adjusting cycling parameters such as upcoming cadence. This increases a lifespan of the operational control components and increases a ride comfort for a rider. This adaptively regulation also reduces a computing load because it mitigates the need to receive continuous cycling inputs. Moreover, the computing system may include a refinement function in order to improve adaptive regulation of the cycling parameters.

In some embodiments, a method of adaptive cadence control of a motor-assisted bicycle comprises: obtaining one or more initialization parameters, the one or more initialization parameters comprising one or more cadence setpoints and one or more cycling adjustment parameters; programming initial settings of the motor-assisted bicycle based on the one or more initialization parameters during activation of the motor-assisted bicycle; after programming the initial settings of the motor-assisted bicycle, obtaining operational signals of the motor-assisted bicycle; obtaining cycling parameters based on the operational signals; generating individual cadence adjustments, each of the individual cadence adjustments generated based on a subset of the cycling parameters; generating an overall cadence adjustment based on the individual cadence adjustments and the one or more of the initialization parameters; generating one or more controlled variable settings based on the overall cadence adjustment; and controlling one or more operational control components of the motor-assisted bicycle based on the one or more controlled variable settings.

In some embodiments, the one or more operational control components comprise a motor and a transmission.

In some embodiments, the transmission comprises a Continuously Variable Planetary (CVP) transmission, a gearless Continuously Variable Transmission (CVT), or a geared transmission having a discrete gear ratio.

In some embodiments, the one or more cycling parameters comprise an applied torque on a pedal of the motor-assisted bicycle and an assist torque that augments the applied torque and is provided by the motor of the motor-assisted bicycle.

In some embodiments, the one or more cycling parameters comprise an applied torque on a pedal of the motor-assisted bicycle, a cadence on the pedal, and an acceleration of the motor-assisted bicycle.

In some embodiments, the one or more cycling parameters comprise an applied torque on a pedal of the motor-assisted bicycle, a cadence on the pedal, an acceleration of the motor-assisted bicycle, and a pitch of the motor-assisted bicycle.

In some embodiments, the individual cadence adjustments comprise a torque-based cadence adjustment, a rotatum-based cadence adjustment, an acceleration-based cadence adjustment, and a pitch-based cadence adjustment.

In some embodiments, the torque-based cadence adjustment is based on the applied torque and the cadence.

In some embodiments, the rotatum-based cadence adjustment is based on a temporal rate of change of the applied torque and the torque-based cadence adjustment.

In some embodiments, the acceleration-based cadence adjustment is based on the rotatum-based cadence adjustment and the acceleration.

In some embodiments, the initialization parameters comprise one or more motor assist parameters, a motor assist parameter of the one or more motor assist parameters indicating an assist mode of providing assist torque to the motor-assisted bicycle to augment the applied torque.

In some embodiments, the cycling adjustment parameters include or indicate an extent of a permitted cadence adjustment.

In some embodiments, a motor-assisted bicycle, comprises: a transmission; an electric motor coupled to the transmission; one or more sensors; and an adaptive cadence control system communicatively coupled to the one or more sensors, the transmission and the electric motor. The adaptive cadence control system comprises one or more hardware processors; and memory storing computer instructions, the computer instructions when executed by the one or more hardware processors configured to perform operations. The operations include obtaining one or more initialization parameters, the one or more initialization parameters comprising one or more cadence setpoints and one or more cycling adjustment parameters; programming initial settings of the motor-assisted bicycle based on the one or more initialization parameters during activation of the motor-assisted bicycle; after programming the initial settings of the motor-assisted bicycle, obtaining operational signals of the motor-assisted bicycle; obtaining cycling parameters based on the operational signals; generating individual cadence adjustments, each of the individual cadence adjustments generated based on a subset of the cycling parameters; generating an overall cadence adjustment based on the individual cadence adjustments and the one or more of the initialization parameters; generating one or more controlled variable settings based on the overall cadence adjustment; and controlling one or more operational control components of the motor-assisted bicycle based on the one or more controlled variable settings.

Any of the above-described methods, systems, and/or non-transitory computer readable media embodiments can be combined in any manner to obtain additional embodiments of the disclosed technology. In particular, any feature, component, aspect, or the like of any given embodiment can be combined with any other feature, component, aspect, or the like of any other embodiment to obtain another embodiment of the disclosed technology.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the disclosed technology are set forth with particularity in the appended claims. A better understanding of the features and advantages of the disclosed technology will be obtained by reference to the following detailed description that sets forth illustrative embodiments, in which the principles of the technology are utilized, and the accompanying drawings of which:

FIG. 1 is a schematic diagram of an e-bike, in accordance with embodiments of the disclosed technology.

FIG. 2 is a schematic diagram illustrating automatic control of operational control components of an e-bike that implements an adaptive cadence control system, in accordance with embodiments of the disclosed technology.

FIG. 3 is a flow diagram illustrating an adaptive cadence control method, in accordance with embodiments of the disclosed technology.

FIG. 4 is a block diagram of an adaptive cadence control system, in accordance with embodiments of the disclosed technology.

FIG. 5 illustrates a transmission, in accordance with embodiments of the disclosed technology.

FIGS. 6-7 illustrate results of implementing the adaptive cadence control system, in accordance with embodiments of the disclosed technology.

FIG. 8 is a block diagram depicting an example computing system that may be used to implement features disclosed herein, in accordance with embodiments of the disclosed technology.

### DETAILED DESCRIPTION

A motor-assisted vehicle is a vehicle in which propulsion assist is provided by an integrated motor or engine. An e-bike is an example motor-assisted bicycle with an integrated electric motor that provides propulsion assist. The motor-assisted vehicle includes operational control components such as a drivetrain and the electric motor. A computing system may control the operational control components of the motor-assisted vehicle or cause the operational control components to be controlled. For example, the computing system generates and outputs one or more operational control signals that cause actuation of the operational control components.

The computing system may receive one or more cycling inputs. Cycling inputs may include one or more cycling setpoint parameters, one cycling adjustment parameters, or one or more motor assist parameters. The cycling setpoint parameters may include or indicate an initial cadence setpoint which establishes an initial or baseline cadence (e.g., pedal cadence). The cycling adjustment parameters may include or indicate an extent of cadence adjustment permitted relative to the cycling setpoint parameters during an upcoming time window (e.g., corresponding to an upcoming trip). The motor assist parameters may include an assist mode which includes protocols of providing assist torque to the e-bike. In some embodiments, the computing system initializes the e-bike based on the cycling inputs. In some embodiments, the computing system adaptively regulates upcoming cycling parameters based on the cycling inputs and based on one or more operational parameters derived or obtained from sensor signals. In general, upcoming cycling parameters may include variable locomotive characteristics of the motor-assisted vehicle, such as upcoming cadence or upcoming applied torque to pedals of the motor-assisted vehicle. In some embodiments, regulating upcoming cycling parameters includes regulating an upcoming cadence. In some embodiments, the operational parameters include a current or previous cadence, applied torque, velocity, or pitch. In some embodiments, at least some of the current or previous operational parameters correspond to a current or previous cycling parameter.

In some embodiments, adaptively regulating upcoming cycling parameters is managed according to an adaptive cadence control algorithm. The adaptive cadence control algorithm may be based on one or more cycling objectives such as increased rider comfort. For example, certain cycling conditions such as uphill roads, rough gravel, or dirt roads with loose surfaces may require increase in applied torque to the motor-assisted vehicle to traverse, assuming that the cadence remains constant. However, beyond a threshold applied torque, further increases in applied torque may be especially strenuous or infeasible. In this situation, the adaptive cadence control algorithm may increase cadence to prevent excessive increases in applied torque.

Adaptively regulating upcoming cycling parameters confers technical benefits such as smoothly adjusting cycling parameters such as upcoming cadence. This increases a lifespan of the operational control components and increases a ride comfort for a rider. This adaptive regulation also reduces a computing load because it mitigates the need to receive continuous cycling inputs. Moreover, the computing system may include a refinement function in order to improve adaptive regulation of the cycling parameters.

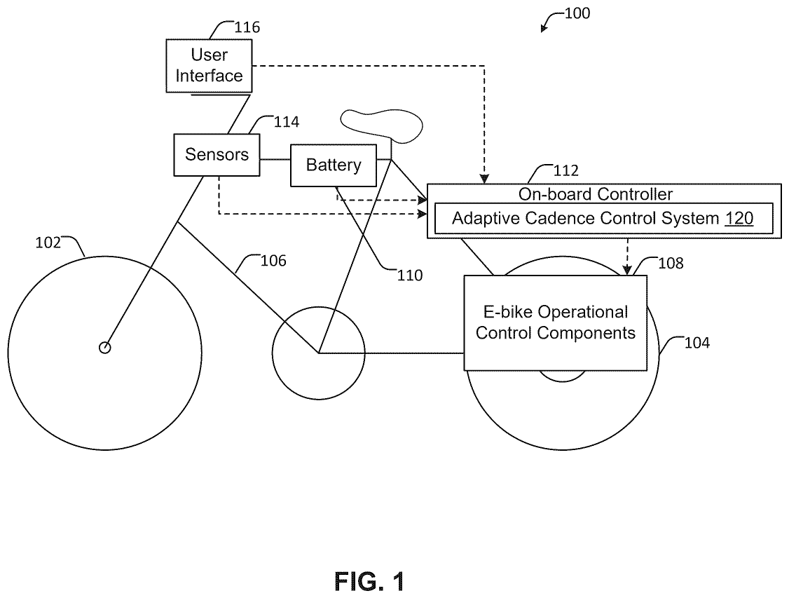

FIG. 1 is a schematic diagram of a motor-assisted vehicle such as an e-bike 100 in accordance with embodiments of the disclosed technology. While embodiments of the disclosed technology may be described herein with reference to an e-bike such as e-bike 100, it should be appreciated that such embodiments are also applicable to other types of motor-assisted vehicles including, without limitation, to motor-assisted tricycles, light electric vehicles (LEVs), or other motor-assisted wheeled vehicles. The e-bike 100 may include bicycle components such as a front wheel 102, a rear wheel 104, a frame 106, and pedals (not shown) to which torque is applied.

The e-bike 100 may further include various operational control components 108 including a device to provide assist torque to a wheel (e.g., an electric motor), a drivetrain, a braking mechanism, a suspension system, a transmission, and the like. Nonlimiting examples of a transmission may include a Continuously Variable Planetary (CVP) transmission, a Continuously Variable Transmission (CVT) such as a gearless CVT, or a transmission with a discrete gear ratio such as a gearbox. A CVT may include a particular type of internally geared hub that does not have fixed gear ratios. A power source may be provided to power the electric motor. For example, a rechargeable battery 110 may be integrated with the e-bike and may supply an input current to the electric motor. The electric motor may generate an output torque based on the input current and may work in coordination with the drivetrain to transfer the torque to a wheel (e.g., the rear wheel 104) of the e-bike 100.

As noted, the operational control components 108 may include a drivetrain, which may include a crankset, a chain, and a gearing system or a gearless system. In some embodiments, the drivetrain may include a set of differently sized gears and derailleurs configured to mechanically move a bike chain across the gears. In other embodiments, an internally geared hub/transmission may be provided that houses the gearing.

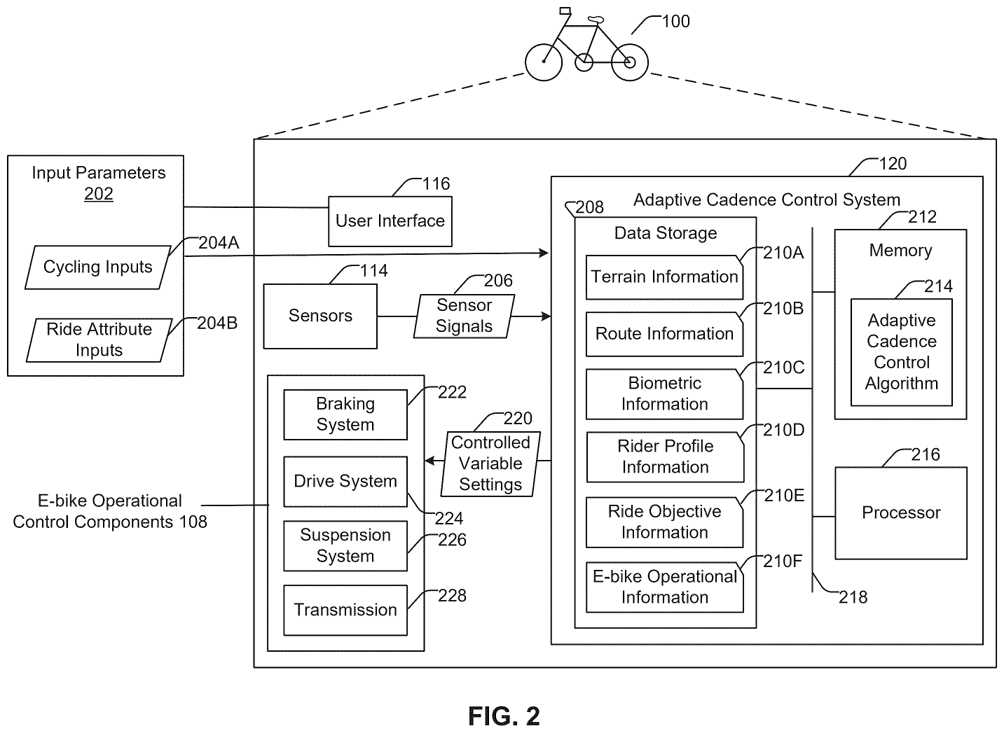

The e-bike 100 may further include an on-board controller 112. The on-board controller 112 may include an adaptive cadence control system 120. The adaptive cadence control system 120 may be communicatively coupled to the operational control components 108. As will be described in more detail with reference to FIG. 2, the adaptive cadence control system 120 may include a memory storing executable instructions of an adaptive cadence control algorithm and a processor configured to access the memory and execute the instructions of the adaptive cadence algorithm. For example, the adaptive cadence control system 120 is configured to generate and send operational control signals (e.g., controlled variable settings) to the drivetrain and electric motor of the e-bike 100 to set/adjust a transmission ratio or a motor assist level (e.g., an amount of assist torque provided by the electric motor), respectively. Moreover, in some embodiments, the adaptive cadence control system 120 is configured to control other operational control components 108 of the e-bike, such as a braking mechanism and a suspension system, according to controlled variable settings. For example, the adaptive cadence control system 120 may be configured to send control signals to set/adjust a braking force applied by the braking system or a suspension pressure of the suspension system.

In some embodiments, the adaptive cadence control system 120 is communicatively coupled to a display via which the adaptive cadence control system 120 may present a user interface 116 (e.g., a graphical user interface (GUI)) for receiving user inputs such as cycling inputs from a rider. In some embodiments, the display may be integrated with the e-bike 100. For example, the display may be mounted to a handlebar of the e-bike 100. In other embodiments, a rider's smartphone, wearable device, or the like may be used to access the user interface 116. For example, a rider may connect his or her device to the adaptive cadence control system 120 using a wireless communication protocol such as Bluetooth, WiFi, or the like, and the adaptive cadence control system 120 may be configured to present the user interface 116 on the rider's mobile device after the connection is established. The adaptive cadence control system 120 may include a wireless network interface to enable such a wireless connection. In some embodiments, a rider may access the user interface 116 via a mobile application on her mobile device. User input received via the mobile application user interface 116 may be transmitted to a server (e.g., a cloud-based server), which in turn, may transmit the information to the adaptive cadence control system 120. In some embodiments, the adaptive cadence control system 120 is configured to communicate with other vehicles on the road, road infrastructure, or the mobile devices of other vehicle occupants or riders using, for example, V2X communication technology.

The e-bike 100 may further include one or more sensors 114. The sensors 114 may be integrated with the e-bike 100 and may be communicatively coupled to the adaptive cadence control system 120. The adaptive cadence control system 120 may receive sensor signals such as one or more current or previous cycling parameters from the sensors 114 periodically in accordance with a designated sampling rate, continuously as the data is captured in real-time, or based on conditions occurring such as threshold changes in value. The sensors 114 may include, without limitation, a Global Positioning System (GPS) receiver configured to obtain GPS location data; an inclination/tilt sensor configured to capture data indicative of a terrain's incline; a speed sensor configured to capture speed/velocity data for the e-bike 100; an inertial sensor (e.g., an accelerometer, gyroscope, magnetometer, etc.) configured to capture acceleration, inclination, and/or vibration data for the e-bike 100; a radar and/or LiDAR configured to capture data indicative of objects/obstacles such as other vehicles, pedestrians, or the like in the environment being traversed by the e-bike 100; biometric sensor(s) configured to capture biometric data of a rider of the e-bike 100 such as heart/pulse rate, pulse oximetry data indicative of an oxygen saturation level for a rider, a VO₂ max level (maximal oxygen consumption) for a rider, or the like; biometric sensor(s) such as a fingerprint sensor, iris scanner, or the like configured to capture data that can uniquely identify a rider, and which can be used to access a corresponding rider profile for the rider; and so forth. In some embodiments, the adaptive cadence control system 120 is configured to receive contextual or environmental data (e.g., weather data, construction data, etc.) from external sensors and/or third-party services/servers. The sensor information may be used to determine or derive cycling parameters of the e-bike 100 or various rider attributes of the rider.

FIG. 2 is a schematic diagram illustrating a system for automatic control of the operational control components 108 of the e-bike 100 in order to support a rider's desired ride objective in accordance with embodiments of the disclosed technology. The on-board adaptive cadence control system 120 is shown in more detail in FIG. 2. In embodiments, the adaptive cadence control system 120 includes a memory 212 and a processor 216. An adaptive cadence control algorithm 214 is shown in FIG. 2 as being loaded into the memory 212. The adaptive cadence control algorithm 214 may include computer/machine-executable instructions executable by the processor 216 to cause operations to be performed to automatically and dynamically adjust operational control parameters such as transmission ratio, motor assist level, braking force, or suspension pressure during a ride of the e-bike 100 according to one or more outputs of the adaptive cadence control algorithm 214.

The memory 212 may be volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. In various implementations, the memory 212 may include multiple different types of memory such as various types of static RAM (SRAM), various types of dynamic RAM (DRAM), various types of unalterable ROM, and/or writeable variants of ROM such as electrically erasable programmable read-only memory (EEPROM), flash memory, and so forth. The memory 212 may include main memory as well as various forms of cache memory such as instruction cache(s), data cache(s), translation lookaside buffer(s) (TLBs), and so forth. Further, cache memory such as a data cache can be a multi-level cache organized as a hierarchy of one or more cache levels (L1, L2, etc.).

The processor 216 may include any suitable processing unit capable of accepting data as input, processing the input data by executing stored computer-executable instructions on the data, and generating output data. The processor 216 may include, without limitation, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor 216 may have any suitable microarchitecture design and may include any of a variety of types of constituent components such as registers, multiplexers, arithmetic logic units, cache controllers for controlling read/write operations to cache memory, branch predictors, or the like. The microarchitecture design of the processor 216 can be made capable of supporting any of a variety of instruction sets.

The adaptive cadence control system 120 may further include data storage 208. The data storage 208 may include removable storage and/or non-removable storage including, but not limited to, magnetic storage, optical disk storage, and/or tape storage. The data storage 208 may provide non-volatile storage of computer-executable instructions and other data. The memory 212 and the data storage 208 are examples of non-transitory computer-readable media as that term, or variants of that term, are used herein. The data storage 208 can store computer-executable code, instructions, or the like (e.g., the ride control algorithm 214) that can be loadable into the memory 212 and executable by the processor 216. The data storage 208 can also store data that can be copied to the memory 212 for use by the processor 216 during the execution of stored instructions. The various types of data illustratively depicted as being stored in the data storage 208 will be described in more detail later in this disclosure.

In some embodiments, the adaptive cadence control system 120 obtains one or more cycling inputs from a rider via the user interface 116. The cycling inputs may take the form of one or more input parameters 202. In some embodiments, the user interface 116 may be a collection of user interfaces that together guide the rider to provide input representing the input parameters 202. In particular, the rider may be presented with a series of prompts, and the rider's responses to the prompts may constitute the input parameters 202. The input parameters 202 may include one or more cycling inputs 204A. In some embodiments, the cycling inputs 204A include one or more cycling setpoint parameters such as an initial cadence setpoint, one or more cycling adjustment parameters, and one or more motor assist parameters. In some embodiments, the cycling adjustment parameters include or indicate an extent of adjustment permitted relative to the cycling setpoint parameters during an upcoming time window. This may correspond to an extent of adaptive cadence control to be applied. In some embodiments, the motor assist parameters indicate an assist mode of the motor that provides assist torque to the e-bike 100. In some embodiments, the motor assist parameters may include discrete motor assist setting options such as turbo, touring, eco, sport, etc. In some embodiments, the adaptive cadence control system 120 obtains the cycling inputs without rider input.

The input parameters 202 may further include ride attribute inputs 204B. The ride attribute inputs 204B may include parameters relating to specific attributes or characteristics of a ride including, without limitation, a target remaining battery level at the conclusion of a ride; a starting location and a destination location for the ride; a desired navigation route between the starting and destination locations; and so forth. With respect to a desired navigation route, the rider may specify a ride attribute input 204B that indicates a particular scenic route that the rider wishes to take (which may be custom-defined by the rider or selected by the rider from a default set of candidate scenic routes); a route with more/less uphill and/or downhill segments; a route with a particular combination/duration of uphill/downhill/flat segments; a route having at least a threshold average grade/incline, at least a threshold average elevation climb, or at least a threshold cumulative elevation climb; a route that includes more/less of a particular type of terrain such as a dirt road surface, concrete road surface, or the like; a route with at least a threshold number of charging stations located along the route; and so forth.

The input parameters 202 may be representative of an overall ride objective for the rider such as having a particular type of ride experience (e.g., a “relaxed” ride), meeting a particular fitness objective (e.g., burning a certain number of calories or maintaining heart rate within a target heart rate zone for a certain duration of the ride), or achieving another type of ride objective (e.g., traversing a particular type of route, having a target amount of battery life remaining at the conclusion of the ride, etc.). Upon receiving the input parameters 202 via the user interface 116, the adaptive cadence control system 120 may store the input parameters 202 as ride objective information 210E in the data storage 210E. The ride objective information 210E may be used by the adaptive cadence control algorithm 214 to determine, at least in part, controlled variable settings (e.g., transmission ratio, motor assist level, braking force, suspension pressure) during the ride that attempt to meet the ride objective represented by the ride objective information 210E.

The data storage 208 may further store other types of information indicative of input variables to the ride control algorithm 214. One or more of the types of information stored in the data storage 208 may be obtained as sensor signals 206 or sensor data converted from the sensor signals 206 from the sensors 114. In particular, the data storage 208 may store terrain information 210A that may indicate a grade/incline of a terrain currently being traversed by the e-bike 100, a type of terrain being traversed (e.g., a type of road surface), or the like. The terrain information 210A may further include grade/incline information for terrains corresponding to candidate routes between a rider's specified starting and destination locations, terrain types for the candidate routes, and so forth. In some embodiments, the terrain information 210A may be captured by a tilt/inclination sensor, an inertial sensor, or the like of the sensors 114. In other embodiments, the terrain information 210A is determined from GPS data captured by a GPS receiver.

The data storage 208 may also store route information 210B. The route information 210B may include, for example, various candidate routes that can be traversed between a starting location and a destination location specified by a rider. The route information 210B may further specify various attributes of a candidate route such as a scenic rating for the route, a number of landmarks along the route, a number of charging stations along the route, expected traffic levels along the route, and so forth.

The data storage 208 may additionally store biometric information 210C. The biometric information 210C may include heart/pulse rate data for a rider, pulse oximetry data indicative of an oxygen saturation level for the rider, a VO₂ max level for the rider, or the like. The sensors 114 may include a heart rate sensor, a pulse oximeter, a VO2 meter, and the like for capturing the above-mentioned biometric information. In some embodiments, a seat of the e-bike 100 may include a weight sensor for capturing a rider's weight. The biometric information 210C may further include fingerprint data captured by a fingerprint sensor, iris data captured by an iris scanner, or the like. Such biometric information can be used to uniquely identify a rider and access a corresponding rider profile for the rider.

The data storage 208 may further store rider profile information 210D for various riders. A rider profile for a particular rider may include, for example, historical input parameters/ride objectives specified by the rider in connection with prior rides; default/preferred input parameters/ride objectives for the rider (e.g., a preferred number of calories to burn or a preferred target heart rate/target heart rate zone for a ride); physical attribute information for the rider (e.g., height, weight, etc.); and so forth. In some embodiments, the rider profile information 210D may be accessed to identify historical/preferred input parameters/ride objectives for a rider and present them to the rider to allow the rider to select a preexisting set of input parameters and thereby expedite the ride objective setup process. In some embodiments, a rider accesses a mobile application that is hosted on one or more servers remote from the e-bike 100. The mobile application may communicate with the adaptive cadence control system 120 to, for example, relay rider input received via one or more user interfaces 116 of the mobile application to the adaptive cadence control system 120. Alternatively, the user interface(s) 116 may be locally stored and hosted on the e-bike 100. In either case, when a rider accesses the user interface(s) 116 for the first time (e.g., as part of accessing a corresponding mobile application on her smartphone or other mobile device for the first time), the rider may be prompted to create to a rider profile. The rider profile may initially include physical attribute information for the rider, biographical information for the rider, initial ride preference information for the rider, and so forth, and may be updated over time to include any of the above-described information as more knowledge is gained about the rider with each subsequent ride.

The data storage 208 may further store e-bike operational information 210F. The e-bike operational information 210F may include various data reflecting operational parameters/characteristics of the e-bike 100. The e-bike operational information 210F may be captured from one or more of the sensors 114 such as a vehicle speed sensor, a pedal cadence sensor, a braking force sensor, a suspension pressure sensor, an electric motor sensor, a transmission sensor, or the like. The e-bike operational information 210F may include, without limitation, cadence, applied torque, vehicle pitch, vehicle speed/velocity, transmission position, motor power, motor current, braking force/pressure, suspension pressure, and the like.

In embodiments, one or more of the types of information stored in the data storage 208, and potentially received as the sensor signals 206 from the sensors 114, may be provided as input variables to the ride control algorithm 214. For instance, GPS location data from the route information 210B, grade/incline data from the terrain information 210A, height/weight data from the biometric information 210C, rider-specified input parameters 202 from the ride objective information 210E, and operational parameters/characteristics of the e-bike 100 (e.g., cadence speed, vehicle speed, transmission position, motor power/input current, etc.) from the e-bike operational information 210F may be provided as input to the ride control algorithm 214. The processor 216 may then execute computer-executable instructions of the ride control algorithm 214 to determine various controlled variable settings 220 over the course of a ride in order to support the rider's ride objective as represented by the input parameters 202. The controlled variable settings 220 may include, for example, a transmission ratio of a transmission 228 of the e-bike 100, an output torque of a drive system 224 (e.g., an electric motor) of the e-bike 100, a braking force applied by a braking system 212 of the e-bike 100, a braking modulation of the braking system 222, and/or a suspension pressure of a suspension system 226 of the e-bike 100. In some embodiments, the braking system 222, the drive system 224, the suspension system 226, and the transmission 228 constitute the e-bike operational control components 108.

In addition, in various embodiments, controlled variable settings 220 other than motor assist level (i.e., output torque of the electric motor) and transmission ratio may be set/adjusted as part of a control scheme adopted by the algorithm 214. Additional controlled variable settings 220 that may be automatically set/adjusted include, without limitation, braking force, braking modulation, and suspension pressure. Including electronically controlled braking along a continuum as a controlled variable setting 220 capable of being set/adjusted may yield a number of additional advantages including regenerative braking and the ability to recharge the battery, particularly during downhill riding, as well as controlled braking to maintain a set pedal cadence without reaching excessive vehicle speed, again particularly during downhill riding.

In some embodiments, the adaptive cadence control algorithm 214 is a self-learning algorithm that receives feedback data from the rider and from the sensor signals 206 and refines the control schemes to perform adaptive cadence control. For instance, the rider may be asked a set of questions via the user interface 116 at the conclusion of a ride. The questions may, for example, ask the rider whether to adjust an extent of adaptive cadence control, or other preferences.

Additionally, or alternatively, the rider may be prompted during the ride to provide the feedback. That is, during the ride itself, the rider may be asked if the extent of adaptive cadence control should be modified. In some embodiments, rider feedback may be sought at periodic intervals during the ride and/or in response to specific ride conditions (e.g., during an uphill segment). By receiving rider feedback in real-time during a ride, the adaptive cadence control algorithm 214 may be able to adjust its control scheme on-the-fly. Although the dynamic and automatic control of controlled variable settings 220 in accordance with embodiments of the disclosed technology obviates the need for direct rider input to the e-bike 100, in some circumstances, the rider may nonetheless wish to provide direct input to set/adjust a transmission ratio, motor assist level, or the like. As such, in some embodiments, the rider feedback during the ride may take the form of direct rider input to set/adjust one or more controlled variable settings 220.

The rider's feedback responses may be stored as feedback data, potentially as part of the rider profile information 210D associated with the rider, and fed into the adaptive cadence control algorithm 214 to refine the algorithm's control schemes for future rides for the rider in order to provide future ride experiences that more closely match the rider's ride objectives. In some embodiments, the feedback data may be specific to a particular rider and used to refine the control schemes adopted for that particular rider's future rides. In other embodiments, the feedback data may be accumulated across multiple riders and used to refine control schemes generally associated with particular input parameters 202 and corresponding ride objectives.

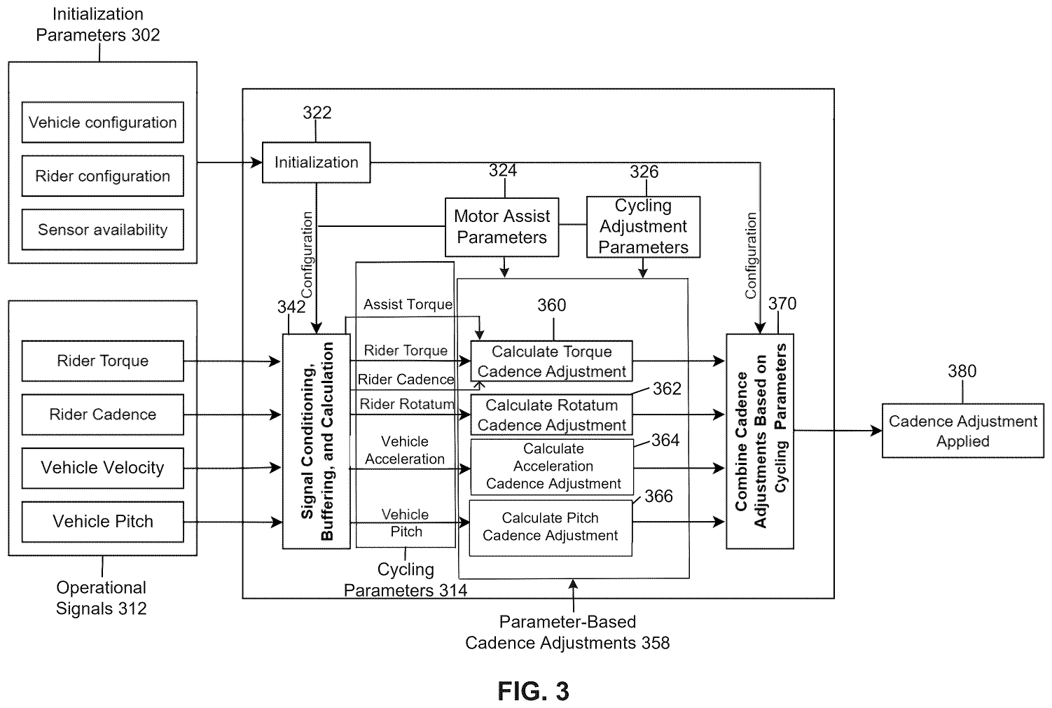

FIG. 3 is a flow diagram of an adaptive cadence control method 350, in accordance with embodiments of the disclosed technology. The adaptive cadence control system 120 may perform or cause at least some of the depicted steps of the adaptive cadence control method 350 to be performed. The adaptive cadence control method 350 may include an initialization step 322. In some embodiments, the initialization step 322 includes programming one or more cycling configurations of the e-bike 100 based on initialization parameters 302. In some embodiments, initialization parameters 302 include or are derived from any of the input parameters 202. The initialization parameters 302 may identify, without limitation, vehicle configuration, rider configuration, or sensor availability. For example, the initialization parameters 302 may include motor assist parameters 324 and cycling adjustment parameters 326. As previously described, the motor assist parameters 324 indicate an assist mode of the motor that provides assist torque to the e-bike 100. The cycling adjustment parameters 326 include or indicate an extent of adjustment permitted relative to the cycling setpoint parameters during an upcoming time window. This may correspond to an extent of adaptive cadence control to be applied.

Programming one or more cycling configurations may include generating configuration files corresponding to different cycling configurations and executing the configuration files. In some embodiments, the initialization parameters 302 are obtained prior to a start of an upcoming trip.

After a trip has started, the adaptive cadence control method 350 may include obtaining one or more operational signals 312. The operational signals 312 may include any or all of the sensor signals 206. The operational signals 312 may be transformed to obtain current (e.g., present or most recent) cycling parameters 314 such as a current applied torque, a current cadence, or a current velocity. In some embodiments, at least a portion of the operational signals 312 indicate a current pitch (e.g., inclination or slope of a road or of the e-bike 100). In some embodiments, the operational signals 312 are indicative of locomotive properties or states of the e-bike 100 during a trip, which may be obtained every measuring period (e.g., every 0.1 seconds).

The adaptive cadence control system 120 may perform a signal transforming step 342, which may include signal conditioning, signal conversion, buffering and calculation. In some embodiments, signal conditioning includes filtering the operational signals 312, such as using a low-pass filter. In some embodiments, signal conversion includes transforming the respective operational signals 312 into one or more actual operational parameters, such as applied torque, cadence, velocity or pitch. In some embodiments, operational parameters include, or are used to derive, cycling parameters 314.

In some embodiments, at least a subset of the operational parameters may be buffered. Buffering includes generating a rolling buffer based on a first-in-first-out (FIFO) principle. The rolling buffer may include a data structure that has an array (e.g., a fixed-size array), a read pointer, and a write pointer. The adaptive cadence control system 120 may write updated operational parameters at the write pointer, and read previous operational parameters starting from the read pointer. The adaptive cadence control system 120 may read older signals before reading most recent signals.

The rolling buffer may include any buffered operational parameters corresponding to a rolling time window such as over a most recent time window (e.g., a most recent two or five second window). The adaptive cadence control system 120 may update the rolling buffer at every measurement period, such as every 0.1 seconds. For example, at time t=5 seconds, the rolling buffer includes buffered operational parameters from time t=0 to time t=5 seconds. At time t=5.1 seconds, the rolling buffer includes buffered operational parameters from time t=0.1 to time t=5.1 seconds.

In some embodiments, calculation includes arithmetic operations to obtain or derive one or more cycling parameters 314. The calculation may include arithmetic operations performed on the buffered operational parameters within the rolling buffer. In some examples, the arithmetic operation includes averaging the buffered operational parameters or generating a fitted parameter based on the buffered operational parameters (e.g., a best fit parameter). In some embodiments, calculation includes arithmetic operations to obtain or derive one or more cycling parameters 314. The calculation may include deriving current cycling parameters 314 from the operational parameters or the buffered operational parameters. For example, the adaptive cadence control system 120 may derive a current rider rotatum based on a rate of change over time of the applied torque. As another example, the adaptive cadence control system 120 may derive an acceleration based on a rate of change over time of the velocity. In some embodiments, the cycling parameters 314 include an assist torque, which represents an amount of torque that the electric motor provides to assist with pedaling to augment the applied torque. The assist torque may be derived based on any of the other cycling parameters 314, the operational parameters, buffered operational parameters, or the initialization parameters 302 (e.g., the motor assist parameters).

The adaptive cadence control system 120 may determine and output one or more parameter-based cadence adjustments 358 (e.g., individual cadence adjustments) based on current or previous cycling parameters 314. The current or previous cycling parameters 314 may include any or all of an applied torque, an assist torque, a rotatum, a pitch, an acceleration, or other cycling parameters 314. For example, in step 360, the adaptive cadence control system 120 determines a torque-based cadence adjustment according to the current applied torque. Alternatively, the adaptive cadence control system 120 determines a torque-based cadence adjustment according to a current total torque which is a combination of the current applied torque and the current assist torque. In step 362, the adaptive cadence control system 120 determines a rotatum-based cadence adjustment according to the current rotatum. In step 364, the adaptive cadence control system 120 determines an acceleration-based cadence adjustment according to the current acceleration. In step 366, the adaptive cadence control system 120 determines a pitch-based cadence adjustment according to the current pitch. In some embodiments, the adaptive cadence control system 120 determines fewer or additional cadence adjustments. In step 370, the adaptive cadence control system 120 combines the determined cadence adjustments, for example, from steps 360, 362, 364, and 366, and outputs an overall cadence adjustment.

In any of steps 360, 362, 364, 366, or 370, the adaptive cadence control system 120 outputs a respective cadence adjustment based on the motor assist parameters 324 or the cycling adjustment parameters 326. The motor assist parameters 324 may include motor assist settings such as turo, touring, eco, sport, etc. The cycling adjustment parameters 326 may include discrete levels (e.g., between 3 and 5 discrete extents of adaptive cadence control) or a continuous range. Discrete levels may include “none,” “low,” “medium,” or “high.” In step 380, the adaptive cadence control system 120 causes the overall cadence adjustment to be applied, for example, by causing adjustment of tilt angles of planets within the transmission 228 if the transmission 228 implements a CVP.

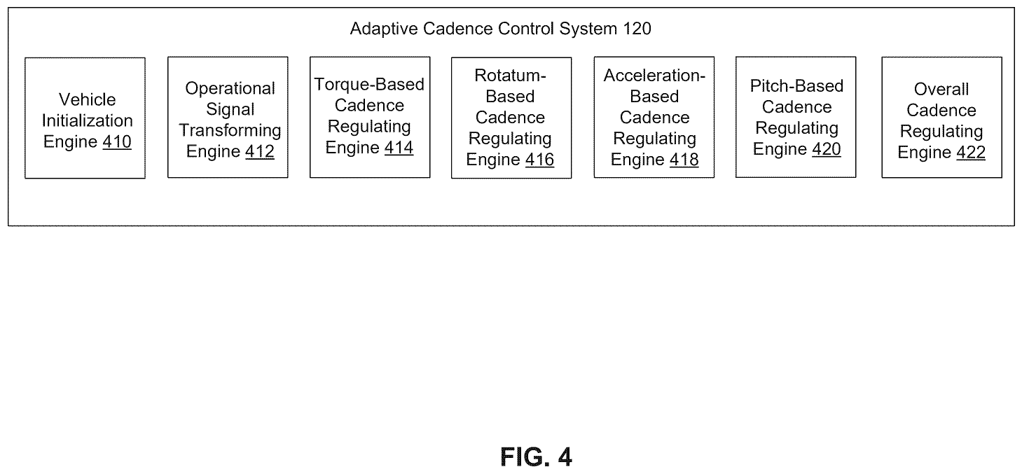

FIG. 4 is a block diagram of the adaptive cadence control system 120, in accordance with embodiments of the disclosed technology. FIG. 4 expands on some of the previous steps described in FIG. 3. In some embodiments, the adaptive cadence control system 120 includes a vehicle initialization engine 410, an operational signal transforming engine 412, a torque-based cadence regulating engine 414, a rotatum-based cadence regulating engine 416, an acceleration-based cadence regulating engine 418, a pitch-based cadence regulating engine 420, and an overall cadence regulating engine 422. Although the foregoing describes the vehicle initialization engine 410, the operational signal transforming engine 412, the torque-based cadence regulating engine 414, the rotatum-based cadence regulating engine 416, the acceleration-based cadence regulating engine 418, the pitch-based cadence regulating engine 420, and the overall cadence regulating engine 422 separately for ease of understanding, the invention is not to be construed as limited to such. In some embodiments, any of the aforementioned engines may be integrated. In some embodiments, additional engines may be implemented.

In some embodiments, the vehicle initialization engine 410 includes hardware, software and/or firmware configured to initialize the e-bike 100 prior to a trip (e.g., during activation of the e-bike 100). In some embodiments, initialization includes programming one or more initial settings of the e-bike 100 based on the initialization parameters 302. Assume a scenario in which the initialization parameters 302 indicate that vehicle pitch (e.g., incline or slope) sensors or signals from vehicle pitch sensors are unavailable. In this scenario, the initialization may include programming the e-bike 100 or the adaptive cadence control system 120 according to a non-pitch-based cadence control mode, in which no pitch-based cadence adjustment is outputted. In contrast, assume that the initialization parameters 302 indicate that signals from vehicle pitch sensors are available. In this scenario, the initialization may include programming the e-bike 100 or the adaptive cadence control system 120 according to a pitch-based cadence control mode.

As another example, assume that the initialization parameters 302 indicate specific rider configurations such as rider preferences or rider modes (e.g., strenuous or relaxed). Then, the initialization may include setting certain applied torque thresholds which identify applied torque constraints of the adaptive cadence control system 120. If a rider configuration is strenuous, then the initialization may include setting a higher applied torque threshold, which may result in lowering the extent of cadence adjustment for certain cycling environments. If a rider configuration is relaxed, then the initialization may include setting a lower applied torque threshold, which may result in increasing extent of cadence adjustment for certain cycling environments.

As another example, assume that the initialization parameters 302 indicate a specific type of e-bike 100. Then, the initialization may include setting certain cycling constraints corresponding to that specific type of e-bike 100. For instance, certain types of e-bikes may have specific permitted speed, acceleration, pitch, cadence, and applied torque ranges.

In some embodiments, the operational signal transforming engine 412 includes hardware, software and/or firmware configured to transform at least a subset of the operational signals 312 into one or more cycling parameters 314. Transforming may include conditioning the operational signals and converting the operational signals into one or more operational parameters. One or more of the operational parameters may be the same as corresponding one or more of the cycling parameters 314. One or more other cycling parameters 314 may be derived from (e.g., via arithmetic operations) one or more of the operational parameters.

For any cycling parameters 314 that are derived from one or more operational parameters, transforming may include buffering at least a subset of the operational parameters, and calculation of the operational parameters or the buffered operational parameters in order to derive one or more cycling parameters 314. In some embodiments, conditioning includes filtering the operational signals using a filter having a cutoff frequency from 0.1 Hertz to 10 Hertz, such as a 1-Hertz filter. In some embodiments, conditioning includes noise or outlier removal. In some embodiments, signal conversion includes transforming the respective operational signals 312 into one or more operational parameters, such as applied torque, cadence, velocity or pitch.

In some embodiments, buffering includes generating a rolling buffer based on a first-in-first-out (FIFO) principle. The rolling buffer may include any buffered operational parameters corresponding to a rolling time window such as a most recent time window (e.g., a most recent two or five second window). For example, the rolling buffer includes a cadence buffer, which includes a rolling buffer of cadence data within a most recent cadence-based time window (e.g., a most recent two-second window). Specifically, the cadence buffer may include cadence measurements spaced apart by a sampling interval such as 0.1 seconds. As another example, the rolling buffer includes an applied torque buffer, which includes a rolling buffer of applied torque data within a most recent torque-based time window (e.g., a most recent five-second window). As another example, the rolling buffer includes a speed buffer, which includes a rolling buffer of speed data within the most recent speed-based time window (e.g., a most recent five-second window).

In some embodiments, calculation includes arithmetic operations to obtain or derive one or more cycling parameters 314 based on the operational parameters or the buffered operational parameters. The calculation may include arithmetic operations performed on the buffered operational parameters within the rolling buffer. In some examples, the arithmetic operation includes averaging the buffered operational parameters. For example, calculation may include averaging the cadence data within the cadence buffer over the most recent cadence-based time window to obtain a current cadence. Calculation may additionally or alternatively include generating a fitted parameter based on the buffered operational parameters (e.g., a best fit parameter) over the most recent torque-based time window or the most recent speed-based time window. In some embodiments, calculation includes obtaining a fitted temporal rate of change of applied torque within the applied torque buffer to obtain a current rotatum. In some embodiments, calculation includes generating a fitted temporal rate of change of speed within the speed buffer to obtain a current acceleration. A fitted temporal rate of change may refer to a best fit of a temporal rate of change, according to one or more algorithms such as a least squares regression algorithm. In some embodiments, calculation includes deriving an assist torque (e.g., a motor assist torque) based on any of the other cycling parameters, operational parameters, buffered operational parameters, or initialization parameters.

Relevant cycling parameters 314 are fed into any of the torque-based cadence regulating engine 414, the rotatum-based cadence regulating engine 416, the acceleration-based cadence regulating engine 418, and the pitch-based cadence regulating engine 420. In some embodiments, the torque-based cadence regulating engine 414 is configured to generate and output a torque-based cadence adjustment. In some embodiments, the rotatum-based cadence regulating engine 416 is configured to generate and output a rotatum-based cadence adjustment. In some embodiments, the acceleration-based cadence regulating engine 418 is configured to generate and output an acceleration-based cadence adjustment. In some embodiments, the pitch-based cadence regulating engine 420 is configured to generate and output a pitch-based cadence adjustment.

In some embodiments, the torque-based cadence adjustment, the rotatum-based cadence adjustment, the acceleration-based cadence adjustment, and the pitch-based cadence adjustment are each characterized as parameter-based cadence adjustments or individual cadence adjustments. In some embodiments, any of the aforementioned parameter-based cadence adjustments may be zero, negative which indicates a decrease in cadence, or positive which indicates an increase in cadence.

In some embodiments, any of the torque-based cadence regulating engine 414, the rotatum-based cadence regulating engine 416, the acceleration-based cadence regulating engine 418, and the pitch-based cadence regulating engine 420 may selectively generate and output a respective parameter-based cadence adjustment. For example, any of the aforementioned regulating engines may generate and output a respective parameter-based cadence adjustment upon satisfaction of a cadence condition. The cadence condition may be based on one or more other parameter-based cadence adjustments. For example, the acceleration-based cadence regulating engine 418 generates and outputs an acceleration-based cadence adjustment subject to a rotatum-based cadence condition. The rotatum-based cadence condition may specify that a sum of the torque-based cadence adjustment and the rotatum-based cadence adjustment is positive. The aforementioned sum may be referred to as a rotatum-based summed adjustment. Thus, if the rotatum-based cadence condition is not satisfied (e.g., the rotatum-based summed adjustment is nonpositive), then the acceleration-based cadence regulating engine 418 may refrain from generating and outputting an acceleration-based cadence adjustment.

In some embodiments, even if any of the torque-based cadence regulating engine 414, the rotatum-based cadence regulating engine 416, the acceleration-based cadence regulating engine 418, and the pitch-based cadence regulating engine 420 generate respective parameter-based cadence adjustments, one or more of the generated parameter-based cadence adjustments may be disregarded if certain cadence conditions are unmet. Disregarding may entail one or more of the generated parameter-based cadence adjustments not being implemented in an overall cadence adjustment. Disregarding may mean setting a particular parameter-based cadence adjustment to zero. For example, the torque-based cadence adjustment, the rotatum-based cadence adjustment, and the acceleration-based cadence adjustment may be disregarded if 1) the rotatum-based summed adjustment is positive and 2) an acceleration-based summed adjustment is non positive. The acceleration-based summed adjustment may include a sum of the rotatum-based summed adjustment and an acceleration-based cadence adjustment. In other words, the acceleration-based summed adjustment is non positive if the acceleration-based cadence adjustment is negative and the magnitude of the acceleration-based cadence adjustment is at least a magnitude of the rotatum-based summed adjustment.

In some embodiments, the torque-based cadence regulating engine 414 includes hardware, software and/or firmware configured to determine a torque-based cadence adjustment. The torque-based cadence regulating engine 414 may determine a nominal torque, determine a first torque difference between a current applied torque and the nominal torque and determine a torque-based cadence adjustment based on the first torque difference. In other words, the first torque difference may be current applied torque minus nominal torque. If the first torque difference is positive, the current torque applied torque is higher than the nominal torque, which may mean that an increase in cadence is needed to counteract the increased torque. Alternatively, the torque-based cadence regulating engine 414 determines a second torque difference between a current total torque and the nominal torque. In that alternative scenario, the torque-based cadence regulating engine 414 may determine a torque-based cadence adjustment based on the second torque difference. The current total torque may include the applied torque summed with the assist torque. The torque-based cadence regulating engine 414 may normalize the torque-based cadence adjustment based on the motor assist parameters 324 or the cycling adjustment parameters 326.

The torque-based cadence regulating engine 414 may determine the nominal torque, conditional upon satisfaction of one or more operational conditions. If nominal torque is unavailable or undetermined, the torque-based cadence regulating engine 414 may refrain from determining a torque-based cadence adjustment. For example, the operational conditions include any or all of a magnitude or absolute value of current applied torque being greater than an applied torque threshold (e.g., 15 Newton-meters), an absolute value of current cadence (e.g., averaged cadences within the cadence buffer) being greater than a cadence threshold (e.g., 30 revolutions per minute), an absolute value of rotatum (e.g., fitted temporal rate of change of applied torque within the applied torque buffer) of less than a rotatum threshold (e.g., 1.5 Newton-meters per second), and an absolute value of current acceleration (e.g., fitted temporal rate of change of speed within the speed buffer) of less than an acceleration threshold (e.g., 1.5 kilometers per second squared). In some embodiments, a total torque threshold (e.g., encompassing both applied torque and assist torque) may be implemented in addition to, or in place of, the applied torque threshold. The torque-based cadence regulating engine 414 effectively prevents torque-based cadence adjustment from occurring under certain outlier operational conditions. These outlier conditions may include any of the acceleration exceeds the acceleration threshold, the applied torque magnitude failing to satisfy the applied torque threshold, the magnitude of current cadence failing to satisfy the cadence threshold, or the absolute value of rotatum exceeding the rotatum threshold (e.g., the torque changing too rapidly).

If the torque-based cadence regulating engine 414 determines that the operational conditions are satisfied, then the torque-based cadence regulating engine 414 may determine the nominal torque based on a previous applied torque and a current applied torque. The previous applied torque may correspond to a most recent measuring period prior to the current measuring period (e.g., 0.1 seconds before the current measuring period). In some examples, the torque-based cadence regulating engine 414 determines the nominal torque based on a weighted sum of the previous applied torque and the current applied torque. For example, the torque-based cadence regulating engine 414 may determine the nominal torque based on 0.99 times the previous applied torque summed with 0.01 times the current applied torque. In some embodiments, determination of the nominal torque may utilize a total torque (e.g., encompassing both applied torque and assist torque) instead of an applied torque.

For purposes of determining the nominal torque, the torque-based cadence regulating engine 414 may obtain the current applied torque by filtering one or more applied torque signals. Filtering may be based on a filter, which may have a cutoff frequency between 0.1 Hz and 10 Hz, such as a Bessel filter having a 1 Hz cutoff frequency. The torque-based cadence regulating engine 414 may obtain the current cadence based on the cadence buffer. The torque-based cadence regulating engine 414 may obtain the current rotatum based on the torque buffer. The torque-based cadence regulating engine 414 may obtain the current acceleration based on the speed buffer.

In some embodiments, the rotatum-based cadence regulating engine 416 includes hardware, software and/or firmware configured to determine a rotatum-based cadence adjustment based on the current rotatum. If rotatum is positive, torque is increasing, which may require additional cadence increase to counteract the increasing torque. In some embodiments, the rotatum-based cadence regulating engine 416 obtains the rotatum-based summed adjustment, which includes a sum of the rotatum-based cadence adjustment and the torque-based cadence adjustment. If the rotatum-based summed adjustment is negative, then the rotatum-based cadence regulating engine 416 may output a combined adjustment based on the rotatum-based and the torque-based cadence adjustments. Otherwise, if the rotatum-based summed adjustment is positive, then the rotatum-based cadence regulating engine 416 may refrain from outputting any cadence adjustment or set the rotatum-based cadence adjustment to zero. The rotatum-based cadence regulating engine 416 may transmit the rotatum-based summed adjustment to the acceleration-based cadence regulating engine 418 to determine an acceleration-based summed adjustment.

In some embodiments, the acceleration-based cadence regulating engine 418 includes hardware, software and/or firmware configured to selectively determine an acceleration-based cadence adjustment based on the current acceleration. In some embodiments, if the rotatum-based summed adjustment is negative, then the acceleration-based cadence regulating engine 418 refrains from generating or outputting any cadence adjustment. If the rotatum-based summed adjustment is positive, the acceleration-based cadence regulating engine 418 obtains the acceleration-based summed adjustment, which includes a sum of the acceleration-based cadence adjustment and the rotatum-based summed adjustment. If the acceleration-based summed adjustment is positive, then the acceleration-based cadence regulating engine 418 may output a combined adjustment based on the acceleration-based summed adjustment. If the acceleration-based summed adjustment is negative, then the acceleration-based cadence regulating engine 418 may refrain from outputting any adjustment or set the acceleration-based cadence adjustment to zero. For example, if speed of the e-bike 100 is decreasing, then the e-bike may require even more cadence increase to counteract the increased torque. If speed of the e-bike 100 is increasing, then the e-bike 100 may not require as much cadence increase.

In some embodiments, the pitch-based cadence regulating engine 420 includes hardware, software and/or firmware configured to determine a pitch-based cadence adjustment based on the current pitch, if one or more pitch sensors are available. In some embodiments, the pitch-based cadence regulating engine 420 determines a pitch-based cadence adjustment based on:

$$C = \frac{{I}_{act} * {A}_{min} - {I}_{act} * {A}_{max} + {I}_{min} * {A}_{max} - {I}_{max} * {A}_{min}}{{I}_{min} - {I}_{max}} ,$$

wherein C is an amount of pitch-based cadence adjustment in RPMs, I_{act} is an actual measured pitch from the pitch sensors or derived from pitch signals, Iₘᵢₙ is a lowest pitch value over a permitted pitch range, Iₘₐₓ is a highest pitch value over the permitted pitch range, Aₘₐₓ is a highest amount of pitch-based cadence adjustment corresponding to the highest pitch value, and Aₘᵢₙ is a lowest amount of pitch-based cadence adjustment corresponding to the lowest pitch value.

As shown, the pitch-based cadence regulating engine 420 may determine a pitch-based cadence adjustment based on a linear relationship between a pitch and an amount of pitch-based cadence adjustment for at least a first pitch range. In some embodiments, the first pitch range may correspond to, or include, the permitted pitch range. One example of a first pitch range may be from 0 to 0.1, or from −0.1 to 0.1. In other embodiments, the pitch-based cadence regulating engine 420 determines a pitch-based cadence adjustment based on a non-linear relationship between a pitch and an amount of pitch-based cadence adjustment for at least the first pitch range or a second pitch range. In one specific example, the first pitch range may include smaller absolute values of pitch while the second pitch range may include larger absolute values of pitch. In some embodiments, the pitch-based cadence regulating engine 420 determines a pitch-based cadence adjustment based on a lookup table.

In some embodiments, the overall cadence regulating engine 422 includes hardware, software and/or firmware configured to combine the determined cadence adjustments from any of the parameter-based cadence adjustments. For example, the overall cadence regulating engine 422 may be configured to combine any of the rotatum-based summed adjustment, the acceleration-based summed adjustment, and the pitch-based cadence adjustment to obtain an overall cadence adjustment. In some embodiments, the overall cadence regulating engine 422 may combine additional adjustments besides the aforementioned adjustments. The overall cadence regulating engine 422 may generate generating one or more controlled variable settings based on the overall cadence adjustment. The overall cadence regulating engine 422 may control one or more operational control components 108 based on the one or more controlled variable settings. For example, the overall cadence regulating engine 422 may generate one or more actuation signals to cause modification of tilt angles of the planets if the transmission 228 includes a CVP.

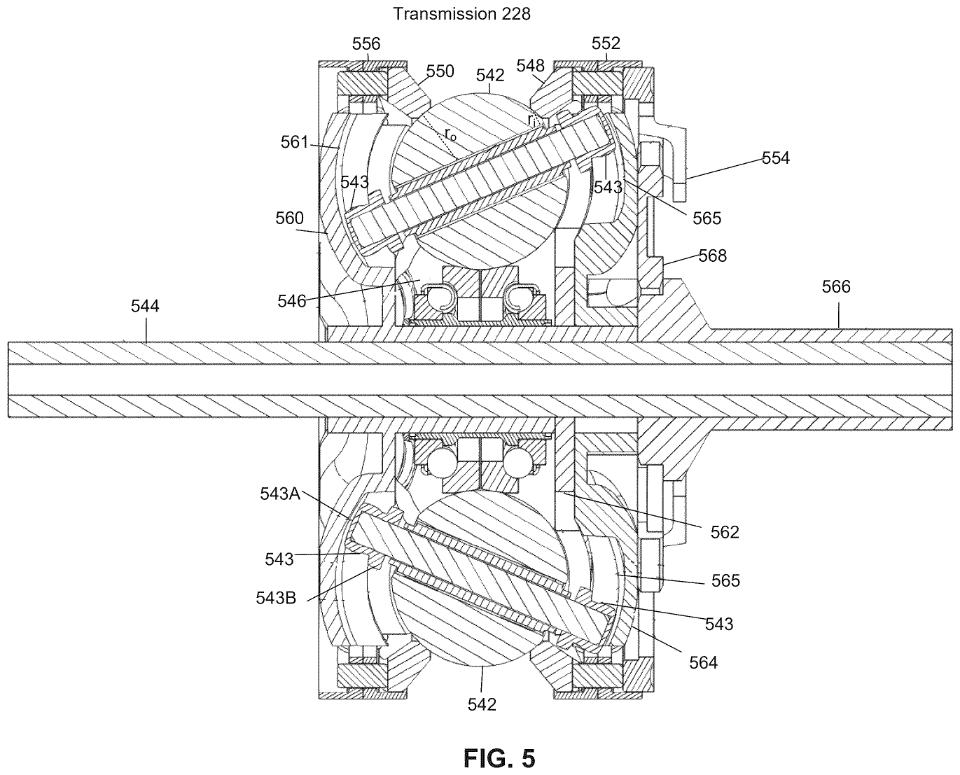

FIG. 5 illustrates an example transmission 228, which includes a CVP transmission in accordance with embodiments of the disclosed technology. It is understood that the transmission 228 is not limited to CVP-type systems. In other embodiments, the transmission 228 includes a CVT transmission such as a gearless CVT transmission, or a transmission with discrete gear ratios.

As illustrated in FIG. 5, the transmission 228 includes one or more planets, one or more input rings and one or more output rings. In the example of a CVP transmission, executing the overall cadence adjustment may include causing a tilt in an axle of the planets. By tilting the axle of a planet 542, a radius of contact rᵢ between the planet 542 and an input ring (e.g., the first traction ring 548), as well as a radius of contact rₒ between the planet 542 and an output ring (e.g., second traction ring 550), is modified. Thus, a ratio of the radius of contact between input and output rings is modified. As rᵢ decreases relative to rₒ, the cadence is increased. As rᵢ increases relative to rₒ, the cadence is increased.

The transmission 228, in particular, a transmission of the transmission 228, contains planets 542 arranged angularly about a main axle 544. The main axle 544 may define a longitudinal axis of the CVP. The traction planet assemblies 542 are in contact with a traction sun assembly 546. The traction sun assembly 546 is located radially inward of the traction planet assemblies 542. The traction sun assembly 546 is coaxial with, the main axle 544. The transmission 228 includes first and second traction rings 548, 550, in contact with each of the traction planet assemblies 542. In one embodiment, the first traction ring 548 is coupled to a first axial force generator assembly 552. The first axial force generator assembly 552 is coupled to an input driver ring 554. The input driver ring 554 is configured to receive an input power. The second traction ring 550 is coupled to a second axial force generator assembly 556. In one embodiment, the second axial force generator 556 is configured to transfer an output power.

In some embodiments, the transmission 228 includes a first stator 560 coupled to a reaction plate 562. The transmission 228 includes a second stator 564 operably coupled to the first stator 560. The first and second stators 560, 564 and the reaction plate 562 are coaxial with the main axle 544. In one embodiment, the first stator 560 and the reaction plate 562 are substantially non-rotatable about the main axle 544. The second stator 564 can be configured to rotate about the main axle 544 relative to the first stator 560. The first stator 560 can be provided with a number of guide slots 561. The second stator 564 can be provided with a number of guide slots 561. Each of the traction planet assemblies 542 couples to the guide slots 561 and 565. In one embodiment, the traction planet assemblies 542 are provided with a planet axle support 543. The planet axle supports 543 have a top-hat cross-section when viewed in the plane of the page of FIG. 5. In some embodiments, the planet axle supports 543 can be formed as an integral component as shown in FIG. 5. In other embodiments, the planet axle supports 543 can be divided into two components: a cap 543A and a ring 543B, where the ring 543B is coupled to the reaction plate 562 and the cap 543A is coupled to the second stator 564, for example. In some embodiments, the ring 543B can be an o-ring (not shown), in which case the planet axle is adapted to receive the o-ring. During operation of the transmission 228, a rotation of the second stator 564 with respect to the first stator 560 induces a skew condition on the traction planet assemblies 542 to thereby facilitate a change in the cadence. The first and second stators 560, 564 are coupled to each of the traction planet assemblies 542.

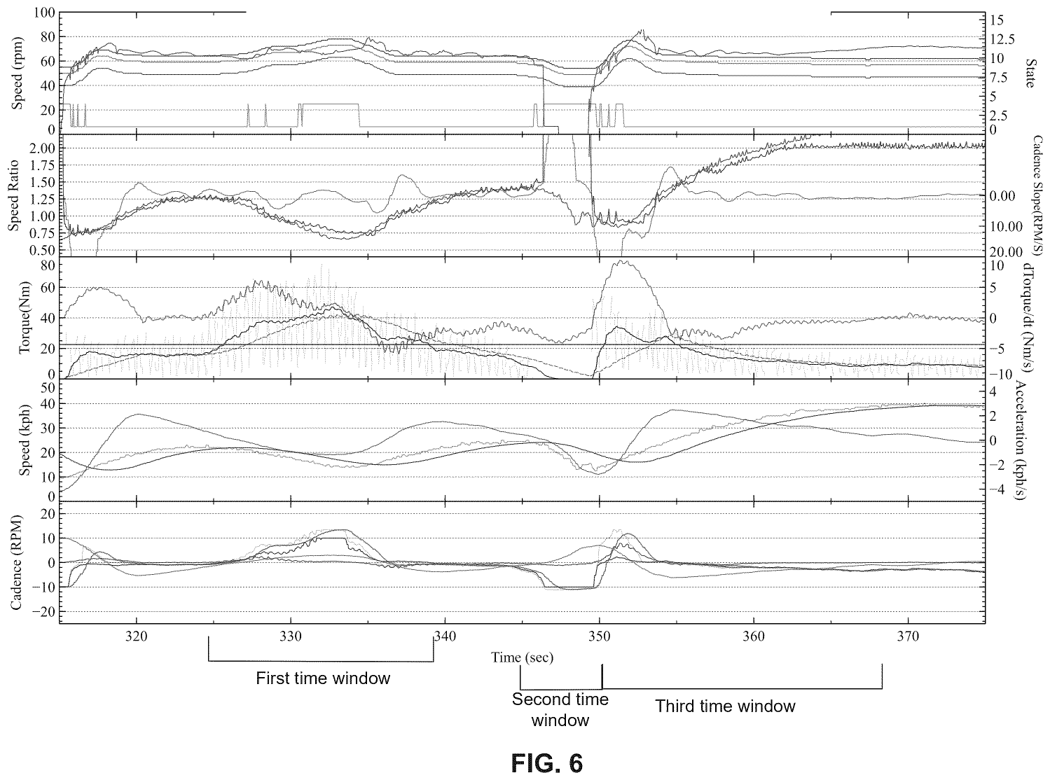

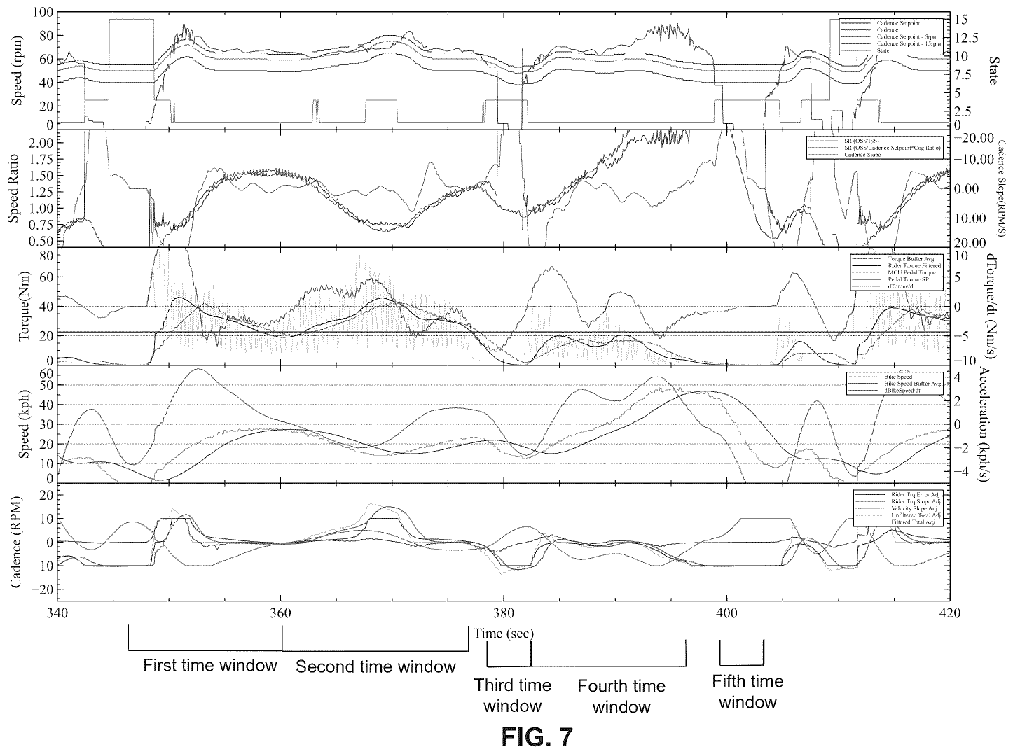

FIGS. 6 and 7 illustrate results of implementing the adaptive cadence control system, in accordance with embodiments of the disclosed technology. In FIG. 6, a first time window (from approximately 324 seconds to 338 seconds) corresponds to a hill climb phase, a second time window corresponds to a coasting phase, and a third time window corresponds to a rolling start launch phase. During the hill climb phase, cadence setpoint may be unaffected leading up to a hill. However, the cadence setpoint may be increased with increased applied torque. Deceleration of the e-bike 100 may further increase the amount of cadence adjustment. After the hill climb phase, the cadence may return to the cadence setpoint. During the coasting phase (from approximately 345 seconds to 350 seconds), the cadence setpoint may be reduced, which may result in a firm pedal feeling when pedaling is resumed. During the rolling start lunch phase (from approximately 350 seconds to 368 seconds), a brief cadence increase occurs at a beginning of a launch to facilitate faster acceleration. Once the vehicle acceleration is sufficient, the cadence returns to the cadence setpoint. In some embodiments, the cadence does not overshoot before peak velocity is reached.

In FIG. 7, a first time window (from approximately 346 seconds to 360 seconds) corresponds to a launch from total stop phase, a second time window from approximately 360 seconds to 376 seconds) corresponds to a hill climb phase, a third time window (from approximately 378 seconds to 382 seconds) corresponds to a coasting phase, a fourth time window (from approximately 382 seconds to 396 seconds) corresponds to a gentle rolling start launch phase, and a fifth time window (from approximately 399 seconds to 403 seconds) corresponds to a coasting phase. During the launch from total stop phase, a brief cadence increase occurs to facilitate faster acceleration. Once sufficient acceleration is attained, the cadence of the e-bike 100 may return to the original cadence setpoint. In some embodiments, the cadence does not overshoot before peak velocity is reached. During the hill climb phase, the cadence setpoint may remain constant leading up to the hill. The cadence setpoint may be increased with increasing rider torque. The cadence setpoint may be further increased by deceleration of the e-bike 100. The cadence may return to the original cadence setpoint, following the hill climb. During the coasting phase, the cadence setpoint may be reduced, the cadence does not overshoot before peak velocity is reached. During the gentle rolling start launch phase, in some embodiments, the cadence does not overshoot.

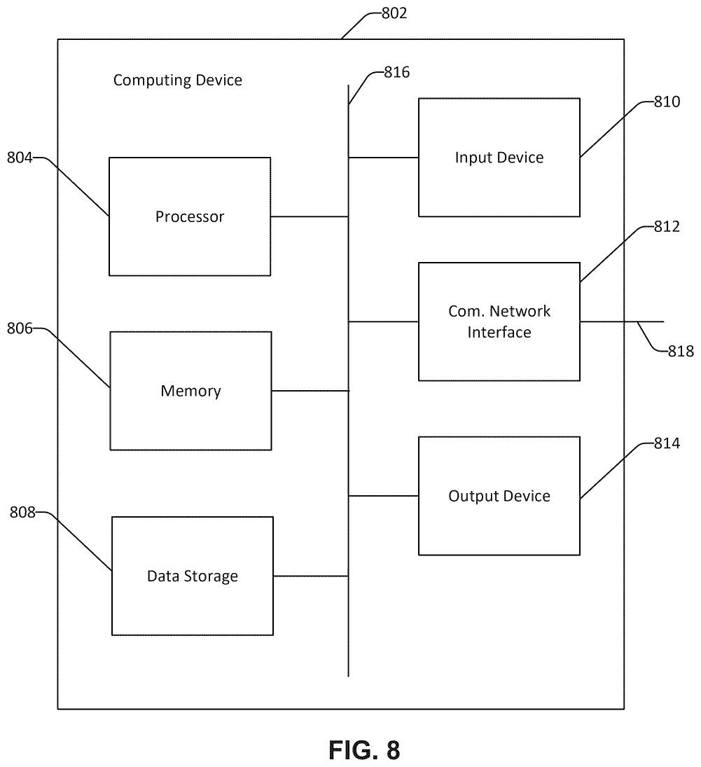

FIG. 8 depicts a diagram of an example of a computing device 802. In some embodiments, the computing device 802 may be a particular implementation of the adaptive cadence control system 120 and may perform some or all of the functionality described herein in connection with the adaptive cadence control system 120. In other embodiments, the computing device 802 may be a device remote from the e-bike 100 (e.g., a cloud-based server) that performs some or all of the functionality of the adaptive cadence control system 120. The computing device 802 comprises a processor 804, memory 806, data storage 808, an input device 810, a communication network interface 812, and an output device 814 communicatively coupled to a communication channel 816. In some examples, the processor 804 is implemented as the processor 216. The processor 804 is configured to execute executable instructions (e.g., programs). In some embodiments, the processor 804 comprises circuitry or any processor capable of processing the executable instructions.

The memory 806 stores data. In some examples, the memory 806 is implemented as the memory 212. Some examples of memory 806 include storage devices, such as RAM, ROM, RAM cache, virtual memory, etc. In various embodiments, working data is stored within the memory 806. The data within the memory 806 may be cleared or ultimately transferred to the data storage 808. In some examples, the data storage 808 is implemented as the data storage 208.

The data storage 808 includes any storage configured to retrieve and store data. Some examples of the data storage 808 include flash drives, hard drives, optical drives, cloud storage, and/or magnetic tape. Each of the memory 806 and the data storage 808 comprises a computer-readable medium, which stores instructions or programs executable by the processor 804.

The input device 810 is any device that inputs data (e.g., mouse and keyboard). The output device 814 outputs data (e.g., a speaker or display). It will be appreciated that the data storage 808, input device 810, and output device 814 may be optional. For example, the routers/switchers may comprise the processor 804 and memory 806 as well as a device to receive and output data (e.g., the communication network interface 812 and/or the output device 814).

The communication network interface 812 may be coupled to a network via the link 818. The communication network interface 812 may support communication over an Ethernet connection, a serial connection, a parallel connection, and/or an ATA connection. The communication network interface 812 may also support wireless communication (e.g., 802.11, WiMax, LTE, 5G, WiFi). It will be apparent that the communication network interface 812 may support many wired and wireless standards.

It will be appreciated that the hardware elements of the computing device 802 are not limited to those depicted in FIG. 8. A computing device 802 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 804 and/or a co-processor located on a GPU.

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some embodiments, the processors or processor-implemented engines may be located in a single geographic location (e.g., within a home environment, an office environment, or a server farm). In other embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to embodiments. It will be apparent to those skilled in the art that various modifications may be made and other embodiments may be used without departing from the broader scope of the present invention(s). Therefore, these and other variations upon the embodiments are intended to be covered by the present invention(s).

Reference to a feature A “and” a feature B may be construed to also encompass the scenario of A “or” B. Reference to A “or” B may be construed to also encompass the scenario of A “and” B. Any reference to “approximate,” “close,” “near,” a “threshold” or “sufficiency” may be construed to encompass any applicable value or degree, such as any applicable value or degree sufficient to satisfy a given outcome. In some examples, a threshold level, similarity or degree thereof may be construed to include any values such as 99.99 percent, 99.9 percent, 99 percent, 98 percent, 95 percent, 90 percent, 80 percent, 75 percent, or any other value therebetween, or any ranges therebetween. Additionally or alternatively, approximately may be construed as qualitatively satisfying some condition.

1. A method of adaptive cadence control of a motor-assisted bicycle, the method comprising:
obtaining one or more initialization parameters, the one or more initialization parameters comprising one or more cadence setpoints and one or more cycling adjustment parameters;
programming initial settings of the motor-assisted bicycle based on the one or more initialization parameters during activation of the motor-assisted bicycle;
after programming the initial settings of the motor-assisted bicycle, obtaining operational signals of the motor-assisted bicycle;
obtaining cycling parameters based on the operational signals;
generating individual cadence adjustments, each of the individual cadence adjustments generated based on a subset of the cycling parameters;
generating an overall cadence adjustment based on the individual cadence adjustments and the one or more of the initialization parameters;
generating one or more controlled variable settings based on the overall cadence adjustment; and
controlling one or more operational control components of the motor-assisted bicycle based on the one or more controlled variable settings.

2. The method of claim 1, wherein the one or more operational control components comprise a motor and a transmission.

3. The method of claim 2, wherein the transmission comprises a Continuously Variable Planetary (CVP) transmission, a gearless Continuously Variable Transmission (CVT), or a geared transmission having a discrete gear ratio.

4. The method of claim 2, wherein the one or more cycling parameters comprise an applied torque on a pedal of the motor-assisted bicycle and an assist torque that augments the applied torque and is provided by the motor of the motor-assisted bicycle.

5. The method of claim 1, wherein the one or more cycling parameters comprise an applied torque on a pedal of the motor-assisted bicycle, a cadence on the pedal, an acceleration of the motor-assisted bicycle, and a pitch of the motor-assisted bicycle.

6. The method of claim 1, wherein the individual cadence adjustments comprise a torque-based cadence adjustment, a rotatum-based cadence adjustment, an acceleration-based cadence adjustment, and a pitch-based cadence adjustment.

7. The method of claim 6, wherein the torque-based cadence adjustment is based on the applied torque and the cadence.

8. The method of claim 7, wherein the rotatum-based cadence adjustment is based on a temporal rate of change of the applied torque and the torque-based cadence adjustment.

9. The method of claim 8, wherein the acceleration-based cadence adjustment is based on the rotatum-based cadence adjustment and the acceleration.

10. The method of claim 5, wherein the initialization parameters comprise one or more motor assist parameters, a motor assist parameter of the one or more motor assist parameters indicating an assist mode of providing assist torque to the motor-assisted bicycle to augment the applied torque.

11. The method of claim 1, wherein the cycling adjustment parameters include or indicate an extent of a permitted cadence adjustment.

12. A motor-assisted bicycle, comprising:
a transmission;
an electric motor coupled to the transmission;
one or more sensors; and
an adaptive cadence control system communicatively coupled to the one or more sensors, the transmission and the electric motor, the adaptive cadence control system comprising:
one or more hardware processors; and
memory storing computer instructions, the computer instructions when executed by the one or more hardware processors configured to perform:
obtaining one or more initialization parameters, the one or more initialization parameters comprising one or more cadence setpoints and one or more cycling adjustment parameters;
programming initial settings of the motor-assisted bicycle based on the one or more initialization parameters during activation of the motor-assisted bicycle;
after programming the initial settings of the motor-assisted bicycle, obtaining operational signals of the motor-assisted bicycle;
obtaining cycling parameters based on the operational signals;
generating individual cadence adjustments, each of the individual cadence adjustments generated based on a subset of the cycling parameters;
generating an overall cadence adjustment based on the individual cadence adjustments and the one or more of the initialization parameters;
generating one or more controlled variable settings based on the overall cadence adjustment; and
controlling one or more operational control components of the motor-assisted bicycle based on the one or more controlled variable settings.

13. The motor-assisted bicycle of claim 12, wherein the one or more operational control components comprise a motor and a transmission.

14. The motor-assisted bicycle of claim 13, wherein the transmission comprises a Continuously Variable Planetary (CVP) transmission, a gearless Continuously Variable Transmission (CVT), or a geared transmission having a discrete gear ratio.

15. The motor-assisted bicycle of claim 13, wherein the one or more cycling parameters comprise an applied torque on a pedal of the motor-assisted bicycle and an assist torque that augments the applied torque and is provided by the motor of the motor-assisted bicycle.

16. The motor-assisted bicycle of claim 12, wherein the one or more cycling parameters comprise an applied torque on a pedal of the motor-assisted bicycle, a cadence on the pedal, and an acceleration of the motor-assisted bicycle.

17. The motor-assisted bicycle of claim 12, wherein the one or more cycling parameters comprise an applied torque on a pedal of the motor-assisted bicycle, a cadence on the pedal, an acceleration of the motor-assisted bicycle, and a pitch of the motor-assisted bicycle.

18. The motor-assisted bicycle of claim 12, wherein the individual cadence adjustments comprise a torque-based cadence adjustment, a rotatum-based cadence adjustment, an acceleration-based cadence adjustment, and a pitch-based cadence adjustment.

19. The motor-assisted bicycle of claim 18, wherein the torque-based cadence adjustment is based on the applied torque and the cadence, the rotatum-based cadence adjustment is based on a temporal rate of change of the applied torque and the torque-based cadence adjustment, and the acceleration-based cadence adjustment is based on the rotatum-based cadence adjustment and the acceleration.

20. The motor-assisted bicycle of claim 19, wherein the initialization parameters comprise one or more motor assist parameters, a motor assist parameter of the one or more motor assist parameters indicating an assist mode of providing assist torque to the motor-assisted bicycle to augment the applied torque, and the cycling adjustment parameters include or indicate an extent of a permitted cadence adjustment.
